(19) United States
(12) Patent Application Publication
(10) Pub. No.: US 2013/0245839 A1
(43) Pub. Date: Sep. 19, 2013

(54) HOT-BEVERAGE PREPARATION APPARATUS HAVING A DATA TRANSMISSION DEVICE

(71) Applicants: Josef Daburger, Siegsdorf-Hammer (DE); Michael Schulze, Munchen (DE)

(72) Inventors: Josef Daburger, Siegsdorf-Hammer (DE); Michael Schulze, Munchen (DE)

(73) Assignee: BSH BOSCH UND SIEMENS HAUSGERÄTE GMBH, Munich (DE)

(21) Appl. No.: 13/881,151

(22) PCT Filed: Oct. 31, 2011
(86) PCT No.: PCT/EP11/69130

§ 371 Date: Apr. 24, 2013

(30) Foreign Application Priority Data
Nov. 12, 2010 (DE) 10 2010 043 856.1

(51) Int. Cl. G05B 9/05

(52) U.S. Cl. CPC G05B 9/05
USPC 700/280

(57) ABSTRACT

A hot-beverage preparation apparatus, in particular a capsule machine, includes an actuator which generates sound emissions and/or vibrations and/or electromagnetic emissions and which can be operated in a normal operating mode for the purpose of preparing hot beverages. The hot-beverage preparation apparatus is designed to transmit data to a receiving device. The actuator can be operated at least in a data transmission mode, which generates sound emissions and/or vibrations and/or electromagnetic emissions, for the purpose of transmitting data to a receiving device.

The invention relates to a hot beverage preparation apparatus, in particular a capsule machine, having an actuator which generates sound emissions and/or vibrations and/or electromagnetic emissions and which can be operated in a normal operating mode for the purpose of preparing hot beverages, the hot beverage preparation apparatus being designed to transmit data to a receiving device.

A coffee brewing apparatus for hot beverage preparation is known from EP 1 302 138 B1. The coffee brewing apparatus according to EP 1 302 138 B1 has an interface with electrical contacts. The interface is designed to receive a mobile storage module, into which data relating to the state of the coffee brewing apparatus or coffee machine can be read. By inserting the storage module into a docking station of a personal computer it is possible to read the data out of the storage module. Such interfaces with electrical contacts can however cease to function due to dirt or can be damaged by inappropriate mechanical strain during insertion of the storage module so that the storage module can no longer be inserted, with the result that the interface can no longer function.

The object of the invention is therefore to allow a more reliable data transmission.

With a hot beverage preparation apparatus of the type mentioned in the introduction this object is achieved in that the actuator can be operated at least in a data transmission mode which generates sound emissions and/or vibrations and/or electromagnetic emissions for the purpose of transmitting data to a receiving device. The invention therefore does not have to provide a separate interface in the form of a component designed for the purpose with electrical contacts for a data exchange. Dirt on or damage to electrical contacts of the interface is therefore excluded. Instead the invention follows the principle of allowing the data transmission in a contactless manner by way of a free air gap, providing for a data transmission by means of emissions for this purpose, said emissions being generated by an actuator that is present. It is therefore possible, in a surprisingly simple manner, to transmit data without cables and in a contactless manner to a receiving device without additional components being required for the purpose. Instead according to the invention an actuator that is present anyway is used with a double function, specifically its conventional function and its additional function as an emitter of sound, vibrations or electromagnetic emissions, i.e. electromagnetic waves or electric or magnetic fields or the like. This function combination reduces manufacturing outlay and increases functional reliability. The emitted information can be decrypted on receipt based on the inventive transmission path so that the sent information can be used. This prevents unwanted use of the transmitted data.

According to the invention the actuator can be operated in normal operating mode and in data transmission mode. Data transmission mode can differ from normal operating mode in that the actuator is operated with different activation signals, which differ for example in respect of frequency or trigger angle when a phase cutting controller is used. It is however also possible to operate the actuator both in normal and data transmission mode with identical activation signals, in other words to operate the actuator in an identical manner. It is possible to operate the actuator in normal operating mode and data transmission mode at the same time, in other words for a data transmission to take place during beverage preparation. Provision can also be made for a pause to be provided between operation in normal operation mode and data transmission mode, within which the actuator is not operated in normal operating mode or data transmission mode, in other words it stops. The duration of the pause here can be such that it is at least longer than the time period for which the actuator stops during operation in normal operating mode or data transmission mode. The signal form used can be sound emissions in the audible or non-audible range, for example ultrasound, the use of ultrasound reducing noise exposure. Alternatively mechanical vibrations can be used, so-called structure-borne or air-borne sound, or electromagnetic emissions, for example in the form of electromagnetic waves, which are generated during operation of the actuator.

In a development provision is made for the data to be measurement values from sensors of the hot beverage preparation apparatus and/or fault codes identifying its malfunctions and/or operating parameters of the hot beverage preparation apparatus and/or information relating to a hot beverage. This allows the function of sensors to be checked in a simple manner, in other words without disassembling the hot beverage preparation apparatus. The sensors can be for example sensors for detecting the throughflow quantity, temperature, electrical voltage or current or for detecting fill levels of operating means, such as water for example. It is therefore possible to check the functional capability of the sensors in a simple manner. Transmitting fault codes, which identify certain malfunctions of the hot beverage preparation apparatus, further simplifies diagnosis in the event of a fault. The automatic diagnosis capability of the hot beverage preparation apparatus is used for this purpose, allowing malfunctions, for example due to a component failure, to be detected by means of a controller of the hot beverage preparation apparatus and a corresponding fault code to be assigned. The transmission of operating parameters such as the number of brewing cycles, the throughflow quantity, the number of descaling operations, read out barcodes of beverage preparation capsules and/or prepared hot beverages allows information to be determined about how long it has been since the last maintenance or the strain to which the hot beverage preparation apparatus has been exposed. A large amount of information can thus be provided if required, allowing a precise diagnosis of the causes of faults. Finally the information about a hot beverage provides information about the beverage or type of beverage that has been or is just being prepared.

In one advantageous development the data can feature at least one start signal identifying the start of the data transmission and a separating signal separating the data components. It is thus possible to transmit data to a receiving device in a simple manner, with the start signal and separating signal ensuring a particularly reliable data transmission without errors. The number of characters to be transmitted can also be transmitted after the start signal. It is then not necessary to transmit an end signal. Alternatively an additional end signal can be transmitted. The separating signal can have a duration of 20 ms and the end signal a duration of 30 ms. Shorter separating or end signals are also possible in so far as mechanical inertia allows them. Other voltage forms, such as square-wave voltages or pulsed direct voltages, can also be used to generate the separating and/or end signals.

In one development of the invention the actuator can be operated first in at least one data transmission mode and then in normal operating mode, in particular in the case of fault detection by the hot beverage preparation apparatus. This allows causes of faults, such as defective sensors, which result for example in the termination of a programmed hot beverage preparation, to be transmitted before program termination. It is however also possible, by operating in data transmission mode after normal operating mode, to signal for example the successful completion of hot beverage preparation or optionally also to give notification of a fault that first occurs during hot beverage preparation.

In a further development of the invention provision is made for it to be possible to operate the actuator for a predefined first minimum time period during normal operating mode and for a predefined second minimum time period during data transmission mode, with the first minimum time period being longer than the second minimum time period. The first minimum operating period here can be for example 100 to 1000 times as long as the second minimum operating period. The overall operating period of the actuator is therefore only slightly increased by the additional operation in data transmission mode, so the actuator does not have to be designed for a much longer overall operating period.

Any component of a hot beverage preparation apparatus is suitable for use as an actuator, in so far as it generates acoustic emissions and/or vibrations and/or electromagnetic emissions during operation, for example the grinder or pump of an automatic coffee machine or the pump of a capsule machine. Provision is however preferably made for the pump for conveying fluid, in particular water, to be configured as an actuator, it being possible to generate acoustic emissions and/or vibrations and/or electromagnetic emissions therewith by specifically starting up the pump during data transmission mode.

In one preferred development the pump can convey a greater quantity of fluid in normal operating mode than in data transmission mode. To this end for example the pump can be operated in a different operating point with less conveying power in data transmission mode than in normal operating mode, for example by means of corresponding activation. The operating period in normal operating mode and data transmission mode also affects the quantity of fluid conveyed, in particular when the pump has a start-up phase, which has to be passed through first, before a stable operating state of the pump is established with an essentially constant conveying rate. The load on the pump is therefore much smaller per unit of time in data transmission mode than in normal operating mode, with the result that the additional energy requirement can be reduced by operation in data transmission mode. At the same time the mechanical strain on the pump in data transmission mode is kept low and its service life is not significantly shortened as a result.

The pump used can be for example a rotary pump or even a piston pump. Provision is however preferably made for the pump to have a spring and a piston supported so that it can move between two end positions, with the spring being tensioned in one of the end positions. The pump therefore has a particularly simple but robust structure, with which a pump chamber, in which the piston is arranged, is filled with fluid, for example water, by a first movement of the piston from the first to the second end position. The spring is tensioned at the same time for example. A further counter movement of the piston from the second to the first end position pushes the fluid out of the pump chamber. An electromagnet is preferably assigned to the pump, by means of which the piston can be moved into one of the two end positions when said electromagnet is energized.

In a further development of the invention provision is made for the hot beverage preparation apparatus to have a first fluid conduction path, along which fluid can be conducted in normal operating mode, and a second fluid conduction path, along which fluid can be conducted in data transmission mode. This allows the actuator, which is configured for example as a pump, also to be activated in data transmission mode so that a conveying rate comparable with that of normal operating mode can be established without fluid being supplied in an unwanted manner to components of the hot beverage preparation apparatus provided for hot beverage preparation, for example a brewing chamber. Two fluid conduction paths are therefore provided, the first of which is assigned to normal operating mode and the second of which is assigned to data transmission mode. This ensures in particular that the quality of the hot beverage is not impaired by a premature and/or uncontrolled supply of fluid, for example insufficiently heated water.

Provision is preferably made here for the first fluid conduction path to lead to a hot beverage container for the hot beverage to be produced and for the second fluid conduction path to lead to a collector for unused fluid. In the case of a capsule machine the collector can be a drip tray below a holder for beverage containers. Alternatively the second fluid conduction path can provide a fluid-conducting connection to a storage tank of the hot beverage preparation apparatus for storing fluid for hot beverage preparation, so that the fluid conveyed in data transmission mode can be reused. This reduces water consumption.

The invention also covers the use of a hot beverage preparation apparatus, in particular a capsule machine, for the purpose of transmitting data to a receiving device, which is designed to receive data sent from an inventive hot beverage preparation apparatus. It can receive the emissions emitted by the actuator and has corresponding receiving means for this purpose, for example microphones or oscillation sensors or antennae. The receiving means also has data processing means for decrypting or translating the received data, so that an operator can understand the transmitted information. Provision can also be made to forward the fault codes by way of an internet connection to allow remote diagnosis.

The principle of the invention is described in yet more detail below based on an example with reference to a drawing, in which:

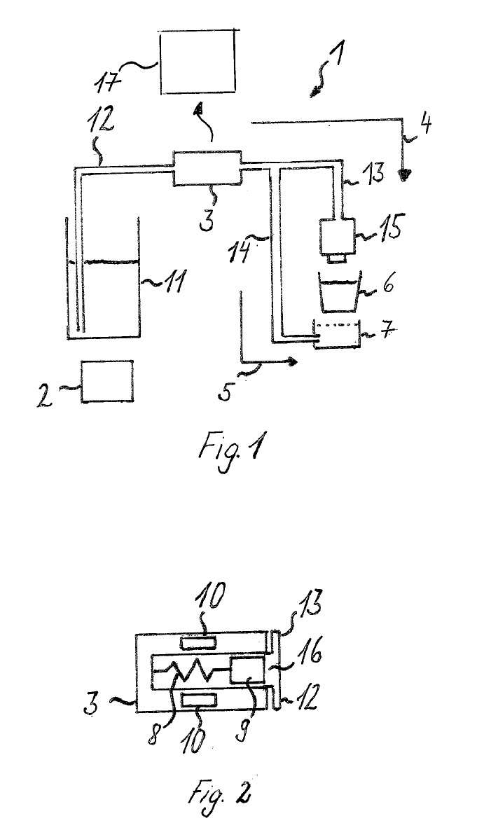

FIG. 1 shows a schematic diagram of a first exemplary embodiment of an inventive hot beverage preparation apparatus in conjunction with a receiving device;

FIG. 2 shows a schematic diagram of a drive of the inventive hot beverage preparation apparatus; and

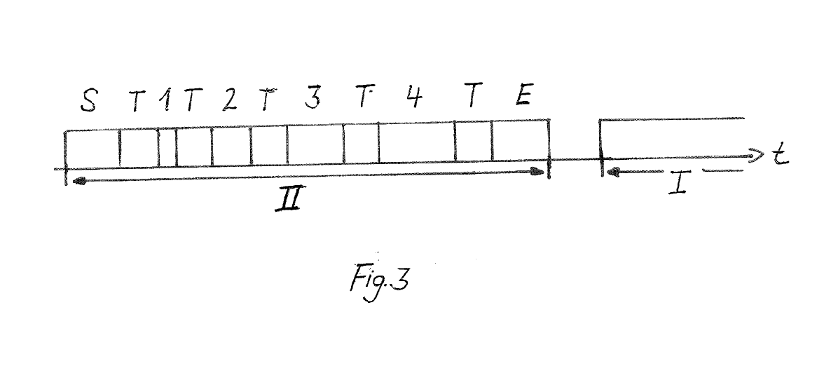

FIG. 3 shows a flow diagram of a data transmission.

Reference is first made to FIGS. 1 and 2. A capsule machine 1 is shown as an example of a hot beverage preparation apparatus. The capsule machine 1 has a water tank 11, which is connected in a fluid-conducting manner by way of a first line section 12 to the actuator, which is configured as a pump 3. A second line section 13 establishes a fluid-conducting connection to a brewing chamber 15 for heating the water, to which a filter screen (not shown) for coffee for example can be joined.

A third line section 14 configured as a bypass branches from the second line section 13 and ends in a collector 7 configured as a drip tray. The capsule machine 1 therefore has a first fluid conduction path 4, which leads from the water tank 11 by way of the first line section 12, the brewing chamber 15 and the second line section 13 to a hot beverage container 6 for the hot beverage to be produced, and a second fluid conduction path 5, along which water can be conducted past the brewing chamber 15 directly into the collector 7. A corresponding valve (not shown) is provided in order optionally to divert the water along the first fluid conduction path 4 or second fluid conduction path 5.

So that an operator can operate the capsule machine 1, operating means 2 are provided to switch the capsule machine 1 on and off and to select an operating program for preparing a specified hot beverage, for example espresso, from a plurality of operating programs for preparing different hot beverages. The operating means 2 are connected by way of lines (not shown) to a controller (not shown) of the automatic coffee maker 1, bringing about the preparation of a desired hot beverage by specific activation of different units or actuators of the capsule machine 1. One such actuator, which is connected by lines (not shown) to the controller for activation purposes, is the pump 3.

The pump 3 has a pump chamber 16, in which a piston 9 is supported so that it can move between two end positions. A spring 8 is arranged so that the spring 8 is tensioned in one of the end positions, thereby pushing the piston 9 into the other end position. In order to be able to move the piston counter to the spring direction an electromagnet 10 is provided, which moves the piston 9 in the direction of said end position during energization, for example by means of the controller. In the energized state the piston 9 is moved counter to the spring force of the spring 8, so that the pump chamber 16 fills with fluid. When there is no energization, the spring 8 relaxes and pushes the piston 9 in the direction of the other end position, thereby conveying the fluid out of the pump chamber 16. A non-return valve (not shown) prevents unwanted backflow.

A receiving device 17 is also provided, which is configured to receive data generated by the capsule machine 1 in data transmission mode in the form of sound waves or emissions. To this end the receiving device 17 has corresponding receiving means, for example microphones or oscillation sensors or antennae. The receiving means also has data processing means for decrypting the received data.

This data is analyzed in the receiving device and compared with stored fault codes. These fault codes themselves or corresponding details can be displayed using display means, for example a text display or a screen.

Reference is now also made to FIG. 3. It shows a flow diagram of a typical operating process for the capsule machine 1. An operator switches the capsule machine 1 on by actuating the operating means 2, which is configured as a touch display.

The controller then performs an automatic diagnosis and determines that a temperature sensor (not shown) for example for detecting the temperature of the fluid is defective. The controller then activates the pump 3 so that in data transmission mode II it first generates a start signal S. The pump 3 here is operated with an alternating voltage of 50 Hz, so that a piston stroke takes place during each half wave, in other words every 10 ms. The start signal S is defined as three piston strokes with a duration of 30 ms. This is followed by the separating signal T, which has a duration of 20 ms, with no piston stroke taking place during this time period and therefore no pump flow. This is followed by the transmission of the fault code for the defective temperature sensor, for which the number sequence “1234” was specified. This specified that one piston stroke (duration 10 ms) is provided for the number “1”, two piston strokes (duration 20 ms) are provided for the number “2”, three piston strokes (duration 30 ms) are provided for the number “3” and four piston strokes (duration 40 ms) are provided for the number “4”, with the separating signal T being provided between the transmission of each of the individual numbers 1, 2, 3, 4. The transmission ends with the end signal E, for which three piston strokes (duration 30 ms) were specified. These acoustic signals are received by the receiving device 17, analyzed and for example displayed or the received fault code is forwarded by way of an internet connection to corresponding analysis software for further processing. If the detected fault allows it, operation then takes place in normal operating mode Ito produce the hot beverage.

Once the received data has been forwarded, for example by means of an internet connection or other wired or wireless data transmission units, said data can be analyzed and made usable in different ways. It can be analyzed for example by means of analysis software in respect of user behavior, in other words for example with regard to the frequency with which certain operating programs and/or beverages are selected. User behavior can therefore be determined and analyzed automatically and in detail using the capsule machine as a data supplier. In a next step this allows personalized or appliance-related messages to be sent to the receiving device of a user. The content of such messages can be for example recommendations or tips relating to the purchase of certain descaling agents, coffee beans and/or capsules or information about new appliance variants and/or customer loyalty programs. Advertising messages can thus be sent to a user in a targeted manner. It is also possible to send messages to a user containing appliance-related information such as notice that a stock of operating means will soon run out, for example a stock of coffee or capsules. Information can also be transmitted, which gives notice of an upcoming appliance maintenance routine, for example a descaling program, so that a user is able to initiate the bringing forward of such a maintenance routine manually if necessary, to avoid unavailability at a certain time due to maintenance.

List of reference characters

1 Capsule machine

2 Operating means

3 Pump

4 First fluid conduction path

5 Second fluid conduction path

6 Hot beverage container

7 Collector

8 Spring

9 Piston

10 Electromagnet

11 Water tank

12 First line section

13 Second line section

14 Third line section

15 Brewing chamber

16 Pump chamber

17 Receiving device

I Normal operating mode

II Data transmission mode

E End signal

S Start signal

T Separating signal

1-10. (canceled)

11. A hot beverage preparation apparatus configured to transmit data to a receiver, the hot beverage preparation apparatus comprising an actuator which constructed to generate at least one of sound emissions, vibrations and electromagnetic emissions, and which is configured to operate in a normal operating mode and at least in a data transmission mode, wherein in the data transmission mode sound emissions, vibrations or electromagnetic emissions are generated, for transmitting the data to the receiving device.

12. The hot beverage preparation apparatus of claim 11, wherein the hot beverage preparation apparatus is a capsule machine.

13. The hot beverage preparation apparatus of claim 11, wherein the data represent at least one of measurement values from sensors of the hot beverage preparation apparatus, error codes identifying malfunctions of the hot beverage preparation apparatus, operating parameters of the hot beverage preparation apparatus, and information relating to a hot beverage.

14. The hot beverage preparation apparatus of claim 11, wherein the data comprise at least one start signal identifying a start of data transmission and a separating signal that separates data components of the data.

15. The hot beverage preparation apparatus of claim 11, wherein the actuator is configured to operate initially in the at least one data transmission mode, when a fault is detected by the hot beverage preparation apparatus, and to thereafter operate in the normal operating mode.

16. The hot beverage preparation apparatus of claim 11, wherein the actuator is operated for a predefined first minimum time period during the normal operating mode and for a predefined second minimum time period during the at least one data transmission mode, with the first minimum time period being longer than the second minimum time period.

17. The hot beverage preparation apparatus of claim 11, wherein the actuator is constructed as a pump for conveying a fluid.

18. The hot beverage preparation apparatus of claim 17, wherein the fluid is water.

19. The hot beverage preparation apparatus of claim 17, wherein the pump conveys a greater quantity of fluid in the normal operating mode than in the data transmission mode.

20. The hot beverage preparation apparatus of claim 17, wherein the pump comprises a spring and a piston supported for movement between two end positions, wherein the spring is tensioned in one of the two end positions.

21. The hot beverage preparation apparatus of claim 11, further comprising a first fluid conduction path, along which fluid can be conducted in the normal operating mode, and a second fluid conduction path, along which fluid can be conducted in the data transmission mode.

22. A method of using a hot beverage preparation apparatus having an actuator, comprising:
operating the actuator in a normal operating mode for preparing a hot beverage; and
operating the actuator in a data transmission mode to generate at least one of sound emissions, vibrations and electromagnetic emissions and transmit data to a receiving device.

23. The method of claim 22, wherein the hot beverage preparation apparatus is a capsule machine.

24. The method of claim 22, wherein the data represent at least one of measurement values from sensors of the hot beverage preparation apparatus, error codes identifying malfunctions of the hot beverage preparation apparatus, operating parameters of the hot beverage preparation apparatus, and information relating to a hot beverage.

25. The method of claim 22, wherein the data comprise at least one start signal identifying a start of data transmission and a separating signal that separates data components of the data.

26. The method of claim 22, wherein the actuator is operated initially in the data transmission mode, when a fault is detected by the hot beverage preparation apparatus, and is thereafter operated in the normal operating mode.

27. The method of claim 22, wherein the actuator is operated for a predefined first minimum time period during the normal operating mode and for a predefined second minimum time period during the at least one data transmission mode, with the first minimum time period being longer than the second minimum time period.

28. The method of claim 22, wherein the actuator is conveying a fluid.

29. The method of claim 28, wherein the fluid is water.

30. The of claim 28, wherein the actuator conveys a greater quantity of fluid in the normal operating mode than in the data transmission mode.
